(19) United States
(12) Patent Application Publication
(10) Pub. No.: US 2005/0041222 A1
(43) Pub. Date: Feb. 24, 2005

(54) Projector

(75) Inventor: Shinji Haba, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/763,176

(22) Filed: Jan. 26, 2004

(30) Foreign Application Priority Data
Feb. 13, 2003 (JP) 2003-34546

(51) Int. Cl. G03B 21/14

(52) U.S. Cl. 353/119; 353/122

(57) ABSTRACT

The present invention provides a projector that surely reduces or prevents the deformation of a lens cap even when the cap is placed on a projection lens while a lamp is on, without powering off the lamp. A projector according to the invention includes a lamp, liquid crystal panels that modulate light from the lamp, a projection lens that projects the modulated light, a lens cap that protects the projection lens, a detector that detects the lens cap on the projection lens, and a projected display controller that controls the liquid crystal panels so as to block or reduce the light from the lamp if the lens cap is found to be detected based on a signal from the detector.

### BACKGROUND OF THE INVENTION

1. Field of Invention

The present invention relates to a projector.

2. Description of Related Art

A related art projector that projects images via a projection lens can be equipped with a cap in order to protect the projection lens from being scratched. The projector also has a lamp as a light source. Since the projector is equipped with a lamp having high luminance, if the cap is accidentally placed on the projection lens while the lamp is on, the heat from the lamp will deform the cap. To address this problem, a lens cap detector is used for a related art liquid crystal projector. When the detector detects the cap on the projection lens, the lamp will be powered off. (See Japanese Unexamined Patent Application Publication No. 2002-258238, for example.)

### SUMMARY OF THE INVENTION

Such a projector, however, is subject to the following problem. The lens cap may be intentionally placed on the projection lens in order to temporarily make a projected display black during a presentation. Even in such a case, the lamp of the related art projector will be powered off on the detection of the cap on the lens. To return to the original display that had been projected before the lamp was powered off, it is necessary to turn on the lamp after taking the cap off the lens. However, the lamp of the projector requires time to turn on again for structural reasons, which does not allow the projector to readily return to the original projected display. In summary, the related art projector requires a waiting time before it is prepared with the lamp being turned on again.

In consideration of the above and/or other problems, the present invention provides a projector that surely reduces or prevents the deformation of a lens cap even when the cap is placed on a projection lens while a lamp is on, without powering off the lamp.

A projector according to the invention includes a lamp, an optical modulator that modulates light from the lamp, a projection lens that projects the modulated light, a lens cap that protects the projection lens, a detector that detects the lens cap on the projection lens, and a projected display controller that controls the optical modulator so as to block or reduce the light from the lamp if the lens cap is found to be detected based on a signal from the detector. With this structure, when the lens cap is placed on the projection lens, the optical modulator is automatically controlled so as to block or reduce light from the lamp. This prevents heat from being generated before the projection lens, and thereby surely reduces or prevents the lens cap from deforming without powering off the lamp, which is the case with a related art projector.

In the projector according to an aspect of the invention, the projected display controller controls the optical modulator so as to return to an original display that is projected before the light from the lamp is blocked or reduced if the lens cap is found to be removed based on a signal from the detector. This means that when the lens cap is removed, no waiting time is required to turn the lamp on, which is necessary for a related art projector, before returning to the original display. Therefore, the projector achieves a user-friendly feature.

In the projector according to an aspect of the invention, the projected display controller controls the optical modulator so as to block or reduce the light from the lamp to make a projected display black, gray, or blue. In order to control the optical modulator to turn a projected display into black, gray, or blue, the light from the lamp is blocked or reduced.

In the projector according to an aspect of the invention, the detector is a microswitch. Thus, a microswitch is used as the detector. Adopting a microswitch that is economical makes it possible to economically provide the detector.

In the projector according to an aspect of the invention, the optical modulator includes a liquid crystal panel, and a polarizing plate on both input and output sides of the liquid crystal panel. Thus, as the optical modulator, a liquid crystal panel, and a polarizing plate on the input side and the output side of the liquid crystal panel are used.

### BRIEF DESCRIPTION OF THE DRAWINGS

FIG. 1 is a schematic of a projector according to an exemplary embodiment of the invention;

FIGS. 2A and 2B are plan views of the projector shown in FIG. 1;

FIG. 3 is a schematic showing a significant configuration of the projector according to an exemplary embodiment of the invention;

FIG. 4 is a flow chart showing the flow of operations according to the exemplary embodiment of the invention; and

FIG. 5 is a schematic showing the structure of optical systems of the projector.

### DETAILED DESCRIPTION OF PREFERRED EMBODIMENTS

An exemplary embodiment of the invention is described below with reference to the accompanying drawings.

Prior to a detailed description of the invention, the structure of optical systems included in a projector according to the invention is described.

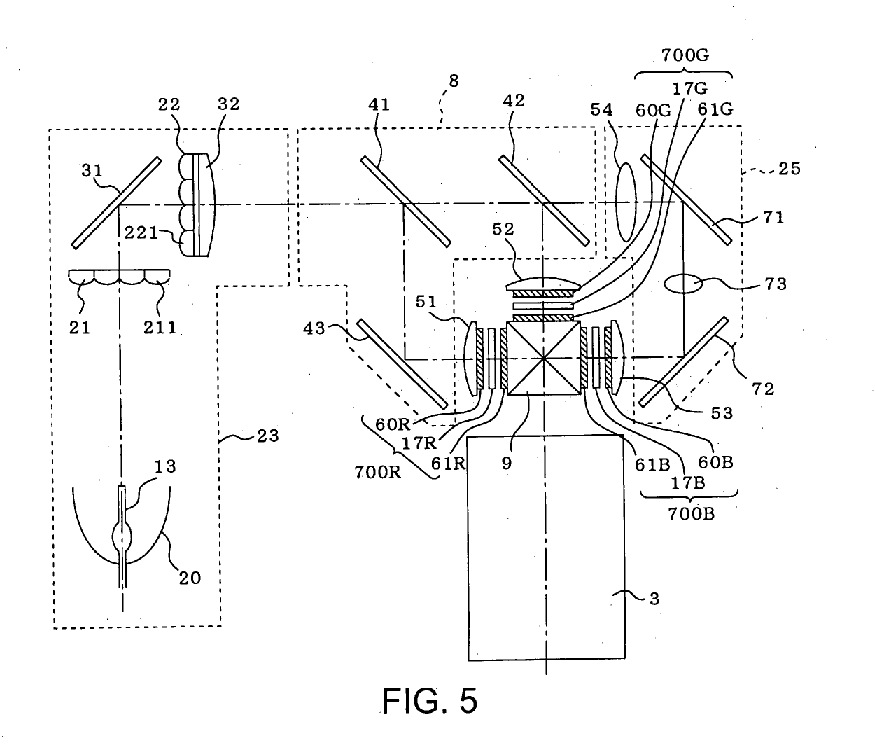

FIG. 5 shows the optical systems of the projector. Referring to FIG. 5, the structure and operations of the optical systems are described.

The optical systems include an illumination optical system 23, a color separation optical system 8, a relay optical system 25, liquid crystal panels 17R, 17G, and 17B, a cross-dichroic prism 9 for color composition, and a projection lens 3.

The illumination optical system 23 includes a lamp 13, a reflector 20, and a first lens array 21 and a second lens array 22 that together make up an integrator lens. The illumination optical system 23 also includes a first reflective mirror 31 that adjusts optical directions, and an overlay lens 32. It is not necessary to include the first reflective mirror 31 when the adjustment of optical directions is not required.

The first lens array 21 is composed of a matrix in which small lenses 211 that each have an almost rectangular outline are arranged in M lines and N rows. Each of the small lenses 211 splits luminous beams that are parallel each other and emitted from the lamp 13 into a plurality of (or M*N) partial beams, and then forms an image of each partial beam in the vicinity of the second lens array 22. The outline of each of the small lenses 211 is shaped to be nearly similar to the areas of the liquid crystal panels 17R, 17G, and 17B in which images are formed. For example, if the aspect ratio (dimensional width-to-depth ratio) of the areas of the liquid crystal panels 17R, 17G, and 17B in which images are formed is 4:3, the aspect ratio of each small lens is set to be 4:3.

The second lens array 22 is also composed of a matrix corresponding to the small lenses 211 of the first lens array 21. In the matrix, small lenses 221 are arranged in M lines and N rows.

The color separation optical system 8 includes a first dichroic mirror 41, a second dichroic mirror 42, and a second reflective mirror 43. The color separation optical system 8 separates light that is emitted from the overlay lens 32 of the illumination optical system 23 into red, green, and blue lights.

The relay optical system 25 serves as an optical path for light transmitted from the second dichroic mirror 42. The relay optical system 25 includes an entrance lens 54, a third reflective mirror 71, a fourth reflective mirror 72, and a relay lens 73.

The liquid crystal panels 17R, 17G, and 17B are provided with polysilicon thin-film transistors used as switching elements, for example, and are adhered and fixed to the cross-dichroic prism 9 via a fixing member so as to face the three sides of the cross-dichroic prism 9. On the input side of the liquid crystal panels 17R, 17G, and 17B, input polarizing plates 60R, 60G, and 60B are provided, while output polarizing plates 61R, 61G, and 61B are provided on the output side of the panels. The liquid crystal panels 17R, 17G, and 17B, the input polarizing plates 60R, 60G, and 60B, and the output polarizing plates 61R, 61G, and 61B form liquid crystal light bulbs 700R, 700G, and 700B, respectively, which are optical modulators according to the invention.

The input polarizing plates 60R, 60G, and 60B, and the output polarizing plates 61R, 61G, and 611B transmit specific polarized light and block the other specific polarized light. The input polarizing plates 60R, 60G, and 60B transmit s-polarized light. More specifically, they transmit s-polarized components of each light beam that is separated by the color separation optical system 8. The s-polarized light passing through the input polarizing plates 60R, 60G, and 60B is modulated by the liquid crystal panels 17R, 17G, and 17B. The output polarizing plates 61R, 61G, and 61B only transmit p-polarized components among the modulated light.

The cross-dichroic prism 9 performs color composition and forms colored images out of red, green, and blue lights. More specifically, lights of the three colors are combined by a dielectric multilayer that reflects red light and a dielectric multilayer that reflects blue light being placed along the diagonal lines of the prism. On the output side of the cross-dichroic prism 9, the projection lens 3 is provided.

Operations of the optical systems are described below. The light emitted from the lamp 13 is reflected on the reflector 20. Then the light is incident on the integrator lens that is composed of the first lens array 21 and the second lens array 22. The integrator lens lets images that are output from each lens cell of the first lens array 21 form on image display planes of the liquid crystal panels 17R, 17G, and 17B by the second lens array 22 and the overlay lens 32. This enhances light utilization efficiency and reduces or eliminates uneven illumination. The light emitted from the overlay lens 32 enters the color separation optical system 8.

The first dichroic mirror 41 of the color separation optical system 8 reflects red optical component of the light beams emitted from the illumination optical system 23, while the first dichroic mirror transmits blue and green optical components of the light beams. The red light reflected by the first dichroic mirror 41 enters a first field lens 51 through the second reflective mirror 43, and then reaches the liquid crystal panel 17R for red light. The first field lens 51 modulates each partial beam to luminous beams that are parallel to its central axis (principal ray). The second and third field lenses 52 and 53 for the liquid crystal panels 17G and 17B, respectively, perform the same function as the first field lens 51 does.

Among the blue and green lights passing through the first dichroic mirror 41, the green light is reflected by the second dichroic mirror 42, enters the second field lens 52, and then reaches the liquid crystal panel 17G for green light. Meanwhile, the blue light passes through the second dichroic mirror 42, enters the relay optical system 25 and then the third field lens 53, and reaches the liquid crystal panel 17B for blue light.

Among the red, green, and blue lights that are separated by the color separation optical system 8, only s-polarized lights passes through the input polarizing plates 60R, 60G, and 60B before entering the liquid crystal panels 17R, 17G, and 17B as mentioned above. Subsequently, the s-polarized light is modulated by the liquid crystal panels 17R, 17G, and 17B in accordance with image data given by a projected display controller 18. Then, the modulated light is emitted to the output polarizing plates 61R, 61G, and 61B. Among the modulated light, only p-polarized light passes through the output polarizing plates 61R, 61G, and 61B, and enters the cross-dichroic prism 9. The light of each color is combined by the cross-dichroic prism 9 to be colored images that are projected from the projection lens 3 on a screen.

The illumination optical system 23 may include a polarization beam splitter that obtains a single state of polarization, i.e., either p- or s-polarized lights, out of illumination light including the both of them from the lamp 13 in a given position, for example, between the second lens array 22 and the overlay lens 32. This enables the light from the lamp 13 to be efficiently used with almost no waste light.

The structure of the optical systems of the projector is disclosed below. Significant features of the invention are described below.

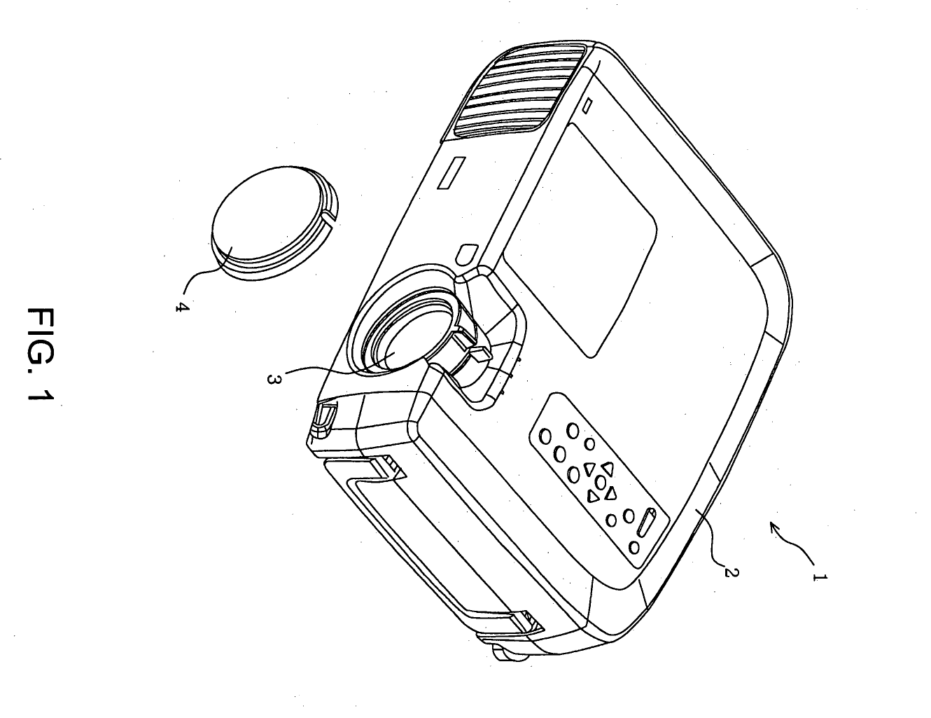

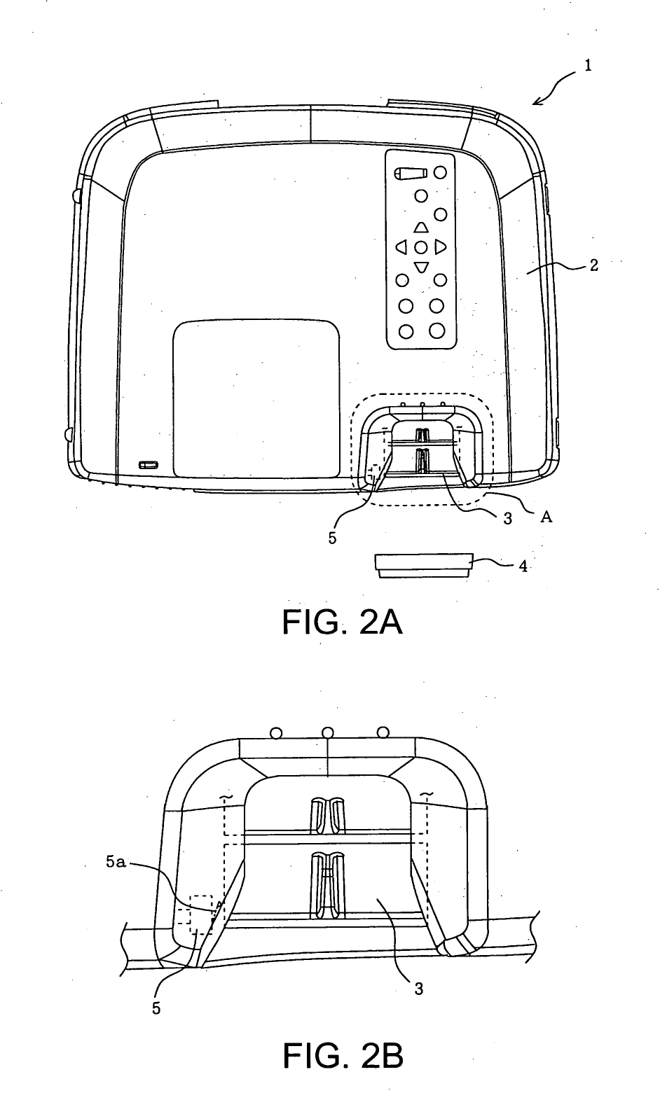

FIG. 1 is a schematic of the projector according to an exemplary embodiment of the invention. FIGS. 2A and 2B are plan views of the projector shown in FIG. 1. More specifically, FIG. 2A is an overall plan view, while FIG. 2B is an enlarged view of the portion indicated by the dotted line A in FIG. 2A.

A projector 1 includes an outer case 2 and the projection lens 3 that is placed on the front side of the outer case 2. The projector 1 is equipped with a lens cap 4 that is easily placed on and removed in order to protect the projection lens 3 from being scratched when the projector is not being used. The lens cap 4 is made of a light blocking member, such as black plastic. Also, a detector 5 is equipped with the outer case 2 of the projector 1 in the vicinity of the projection lens 3. The detector 5 detects the lens cap 4 being placed on. A microswitch is used as the detector 5.

When the lens cap 4 is put on the projection lens 3, an internal switch of the microswitch is turned “on” by pushing a lever 5a from the side surface of the lens cap 4. Then, the microswitch outputs an “on” signal to a controller 12 that is described in detail below. When the lens cap 4 is removed, the lever 5a is returned to its original position and the internal switch is turned off. Then, the microswitch outputs an “off” signal to the controller 12. The detector 5 is not always a microswitch. It may be a detector using other mechanical or optical sensors. Adopting a microswitch that is known for its simple and economical structure makes it possible to economically provide the detector 5.

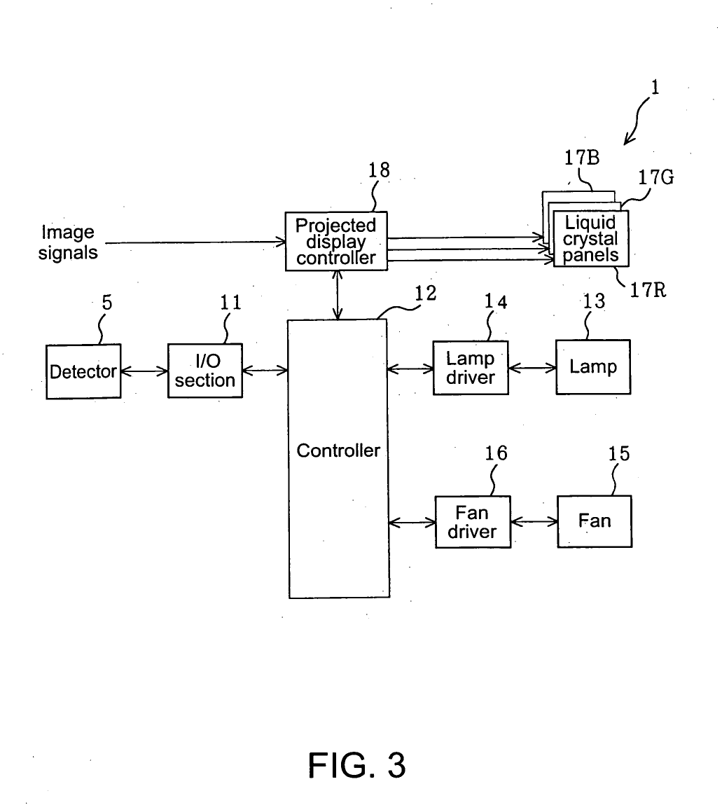

FIG. 3 is a schematic showing the major configuration of the projector according to an exemplary embodiment of the invention.

The projector 1 includes an input/output (I/O) section 11 and the controller 12. The I/O section 11 receives “on” and “off” signals from the detector 5 and outputs the signals to the controller 12. The controller 12 is composed of a microcomputer that controls not only the projected display controller 18 (described below) based on the signals from the I/O section 11, but also the entire system of the projector 1.

The projector 1 also includes the lamp 13 that is turned on by powering on the projector 1; a lamp driver 14 that drives the lamp 13; a fan 15 that cools down the lamp 13 and/or the liquid crystal panels 17R, 17G, and 17B; and a fan driver 16 that drives the fan 15.

The projector 1 further includes the projected display controller 18. The projected display controller 18 controls various operations of the liquid crystal panels 17R, 17G, and 17B included in the liquid crystal light bulbs 700R, 700G, and 700B (shown in FIG. 5) according to control signals from the controller 12, as well as sending image signals that are input from an external device to the liquid crystal panels 17R, 17G, and 17B.

Each element is described in greater detail below.

The controller 12 receives “on” and “off” signals from the detector 5 via the I/O section 11, and outputs control signals according to the received signals to the projected display controller 18. In other words, if the detector 5 inputs an “on” signal, a light blocking signal is output to the projected display controller 18. The light blocking signal is to block or reduce light from the lamp 13 at the liquid crystal panels 17R, 17G, and 17B. More specifically, the light blocking signal is to control the liquid crystal panels 17R, 17G, and 17B so as to turn a projected display into black, gray, or blue. If the detector 5 inputs an “off” signal, a light-blocking release signal is output to the projected display controller 18. The light-blocking release signal is to go back to the original display that had been projected before the light from the lamp 13 was blocked or reduced by the liquid crystal panels 17R, 17G, and 17B.

The projected display controller 18 reads image displayed by a computer, etc., or image signals previously stored inside, and sends out such signals as RGB signals to the liquid crystal panels 17R, 17G, and 17B. If the controller 12 inputs a control signal that is to output the light blocking signal, the projected display controller 18 controls the liquid crystal panels 17R, 17G, and 17B so as to make a projected display black, gray, or blue.

In order to turn a projected display into black or gray, all or part of the light passing through the liquid crystal panels 17R, 17G, and 17B is blocked by the output polarizing plates 61R, 61G, and 61B (shown in FIG. 5), which are placed on the output side of the liquid crystal panels 17R, 17G, and 17B included in the liquid crystal light bulbs 700R, 700G, and 700B (shown in FIG. 5). The projected display controller 18 thus controls the liquid crystal panels 17R, 17G, and 17B, so that the light passing through the liquid crystal panels 17R, 17G, and 17B does not pass through the output polarizing plates 61R and 61G.

In order to turn a projected display into blue, red and green lights are blocked by the output polarizing plates 61R and 61G (shown in FIG. 5). The projected display controller 18 thus controls the liquid crystal panels 17R and 17G, so that the light passing through the liquid crystal panels 17R and 17G does not pass through the output polarizing plates 61R and 61G.

In an example described below, the projected display controller 18 controls the liquid crystal panels 17R, 17G, and 17B so as to turn a projected display into black when the controller 12 inputs a light blocking signal to the projected display controller 18.

The lamp driver 14 is a power circuit that supplies power to drive the lamp 13. More specifically, the lamp driver 14 transforms voltage of power supplied from an external source and supplies the power to the lamp 13. The amount of power supplied by the lamp driver 14 to the lamp 13 is controlled by the controller 12. Thus, the luminance of the lamp 13 is adjusted.

The fan driver 16 includes a motor. The fan driver 16 supplies power to drive the fan 15, which sends air to cool down the lamp 13 and/or the liquid crystal panels 17R, 17G, and 17B. The amount of power supplied by the fan driver 16 is controlled by the controller 12. Since a lamp with high luminance generates considerable heat, it is particularly important to take the cooling of the lamp into consideration.

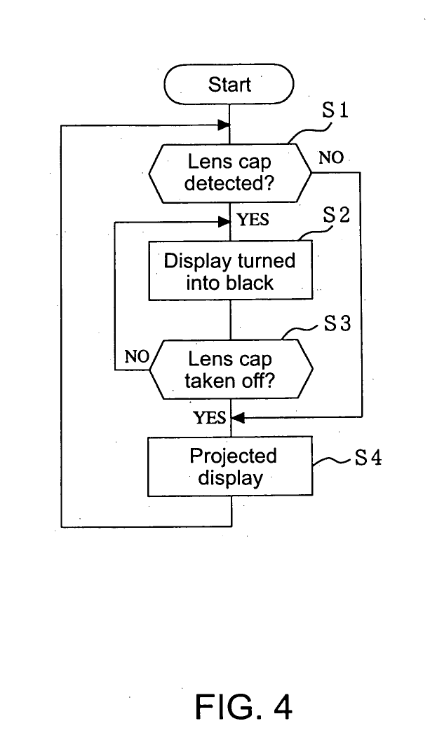

The operation of each element according to the exemplary embodiment is described below in greater detail. FIG. 4 is a flow chart showing the flow of operations according to this exemplary embodiment.

While the projector 1 is powered on and the lamp 13 is on to project images, if the lens cap 4 is put on (S1), the detector 5 inputs an “on” signal to the controller 12 via the I/O section 11. The controller 12 receives the “on” signal from the detector 5 and finds that the lens cap 4 is put on. Then, the controller 12 outputs a light blocking signal to the projected display controller 18. Consequently, the projected display controller 18 controls the liquid crystal panels 17R, 17G, and 17B so as to make a projected display black (S2).

The projected display is made black by blocking all the light from the lamp 13 by the output polarizing plates 61R, 61G, and 61B (shown in FIG. 5) as mentioned above. Since the light from the lamp 13 does not reach the projection lens 3 while the display is made black, no heat is generated before the projection lens 3. This makes it possible to reduce or prevent the lens cap 4 from deforming even if the lens cap 4 is placed on the projection lens 3 during a presentation to intentionally make a projected display black or otherwise accidentally.

In order to turn a projected display into gray or blue, light can be controlled in the same manner. In other words, the light from the lamp 13 is appropriately blocked by the output polarizing plates 61R, 61G, and 61B, and thereby the amount of light reaching the projection lens 3 is reduced. Therefore, it is possible to reduce or prevent the lens cap 4 from deforming.

The projected display is kept black until the lens cap 4 is taken off, that is, the detector 5 inputs an “off” signal to the controller 12. When the detector 5 inputs an “off” signal, the controller 12 finds that the lens cap 4 is taken off (S3). Then, the controller 12 outputs a light-blocking release signal to project images again to the projected display controller 18. Consequently, the projected display controller 18 controls the liquid crystal panels 17R, 17G, and 17B so as to project images on the display (S4). Thus, the projector is ready for returning to the original projected display. Subsequently, the projector goes over the process from the step S1 as required. The state of the step S4 continues (S1—NO) until the controller 12 receives an “on” signal to go onto the step S1. When the lens cap 4 is put on, which triggers the process from the step S1 (S1—YES), the aforementioned step S2 follows.

The above-mentioned case is an example in which the lens cap 4 is placed on while the projector projects images. It is also possible to detect the lens cap 4 upon turning on the power. The controller 12 receives an “on” or “off” signal from the detector 5 via the I/O section 11 upon turning on the power. If the controller 12 finds that the lens cap 4 is placed on based on the signal from the detector 5 (S1), that is, the power is turned on while the lens cap 4 is placed on, the controller 12 starts the step S2 so as to make a projected display black. Meanwhile, if the controller 12 finds the lens cap 4 is not put on, that is, the power is turned on while the lens cap 4 is not placed on, the controller 12 starts the step S4 so as to start projecting images.

As described above, according to this exemplary embodiment of the invention, the liquid crystal panels 17R, 17G, and 17B included in the liquid crystal light bulbs 700R, 700G, and 700B (shown in FIG. 5) are controlled when the lens cap 4 is put on the projection lens 3. Thus, the light from the lamp 13 is blocked or reduced by the liquid crystal panels 17R, 17G, and 17B. This reduces or prevents heat from being generated before the projection lens 3, and thereby surely reduces or prevents the lens cap 4 from deforming without powering off the lamp, which is a problem for a related art projector. Accordingly, it is possible to surely reduce or eliminate the problem of the deformation of the lens cap 4 when the lens cap 4 is placed on the projection lens 3 accidentally.

It is also possible to reduce or eliminate the same problem when the lens cap 4 is placed on intentionally so as to temporarily make a projected display black during a presentation. In other words, the only thing required to temporarily make a projection display black is to place the lens cap 4 on the projection lens 3 according to the invention. The problem of the deformation of the lens cap 4 is reduced or eliminated, so that the projector achieves a user-friendly feature. Also, in this example, as the lens cap 4 is made of a light blocking member, such as black plastic, the lens cap 4 perfectly blocks light and surely makes the display black.

As mentioned above, the deformation of the lens cap 4 is reduced or prevented without powering off the lamp 13. According to the invention, it is possible to return to the original display that had been projected before the lens cap was placed on upon taking off the lens cap 4. This means that no waiting time is required to turn the lamp on, which is necessary for a related art projector, before going back to the original display. The projector achieves a user-friendly feature.

In the exemplary embodiment described above, an example where the invention is applied to a projector equipped with transmissive liquid crystal panels is shown. The invention can also be applied to a projector equipped with reflective liquid crystal panels. A “transmissive” liquid crystal panel means that the panel transmits light, while a “reflective” liquid crystal panel means that the panel reflects light.

Also, in the exemplary embodiment described above, liquid crystal panels are used as modulating elements of optical modulators that modulate light from a lamp. Instead of liquid crystal panels, devices using a micromirror and charge-coupled devices (CCD) can also be used, for example. The invention can be also applied to a projector with such devices.

Moreover, the invention can also be applied to both of the following types of projectors: a front-projection projector that projects images from the side on which the images are viewed and a rear-projection projector that projects images from the opposite side of the side on which the images are viewed.

Also, in the exemplary embodiment described above, an example where the invention is applied to a three-panel projector that is equipped with three liquid crystal panels is shown. The invention can be also applied to a two- or four-panel projector that is equipped with two or four liquid crystal panels, for example.

1. A projector, comprising:
a lamp;
an optical modulator that modulates light from the lamp;
a projection lens that projects the modulated light;
a lens cap that protects the projection lens;
a detector that detects the lens cap on the projection lens; and
a projected display controller that controls the optical modulator so as to block or reduce the light from the lamp if the lens cap is found to be detected based on a signal from the detector.

2. The projector according to claim 1,
the projected display controller controlling the optical modulator so as to return to an original display that is projected before the light from the lamp is blocked or reduced if the lens cap is found to be removed based on a signal from the detector.

3. The projector according to claim 1,
the projected display controller controlling the optical modulator so as to block or reduce the light from the lamp to turn a projected display into black, gray, or blue.

4. The projector according to claim 1,
the detector being a microswitch.

5. The projector according to claim 1,
the optical modulator including a liquid crystal panel, and a polarizing plate on both input and output sides of the liquid crystal panel.
